(19) United States
(12) Patent Application Publication
(10) Pub. No.: US 2025/0378177 A1
(43) Pub. Date: Dec. 11, 2025

(54) SYSTEMS AND METHODS FOR RESOLVING CODE VULNERABILITIES THROUGH COLLABORATIVE AGENTS

(71) Applicant: ShiftLeft, Inc., San Jose, CA (US)

(72) Inventor: Chetan Conikee, Santa Clara, CA (US)

(21) Appl. No.: 19/230,585

(22) Filed: Jun. 6, 2025

Related U.S. Application Data
(60) Provisional application No. 63/657,459, filed on Jun. 7, 2024.

(51) Int. Cl. G06F 21/57; G06F 21/55

(52) U.S. Cl. CPC G06F 21/577; G06F 21/554

(57) ABSTRACT

Systems and methods for resolving code vulnerabilities through collaborative agents which may include accessing a code base of an identified vulnerability; configuring a plurality of autonomous agents, each comprising a predefined agent role associated with application security remediation process; executing a directed workflow of the plurality of agents, wherein the workflow is a conditional sequence of agent-driven processing steps for generating a proposed resolution to the identified vulnerability; and outputting a candidate resolution for the vulnerability based on results produced by the workflow.

### CROSS-REFERENCE TO RELATED APPLICATIONS

This application claims the benefit of U.S. Provisional Application No. 63/657,459, filed on 7 Jun. 2024, which is incorporated in its entirety by this reference.

### TECHNICAL FIELD

This invention relates generally to the field of software security, and more specifically to a new and useful system and method for resolving code vulnerabilities through collaborative agents.

### BACKGROUND OF THE INVENTION

Software security is a growing concern as modern applications become more complex and exposed to an increasing number of attack vectors. The widespread use of artificial intelligence and large language models (LLMs) in software development, particularly for code generation, introduces new risks and challenges. While these tools can improve productivity, they may also produce insecure or flawed code that is difficult to verify. At the same time, advances in AI may also enable attackers to identify and exploit vulnerabilities more efficiently, increasing the urgency of effective security practices. Autonomous AI agents are emerging to solve multi-step problems, but ensuring the reliability and accuracy of their outputs remains a significant challenge.

Thus, there is a need in the software security field to create a new and useful system and method for resolving code vulnerabilities through collaborative agents. This invention provides such a new and useful system and method.

### BRIEF DESCRIPTION OF DRAWINGS

FIG. 1 is a flowchart representation of a method.

FIG. 2 is a flowchart representation of a method variation.

FIG. 3 is a detailed process diagram of agent processes of an exemplary set of agents.

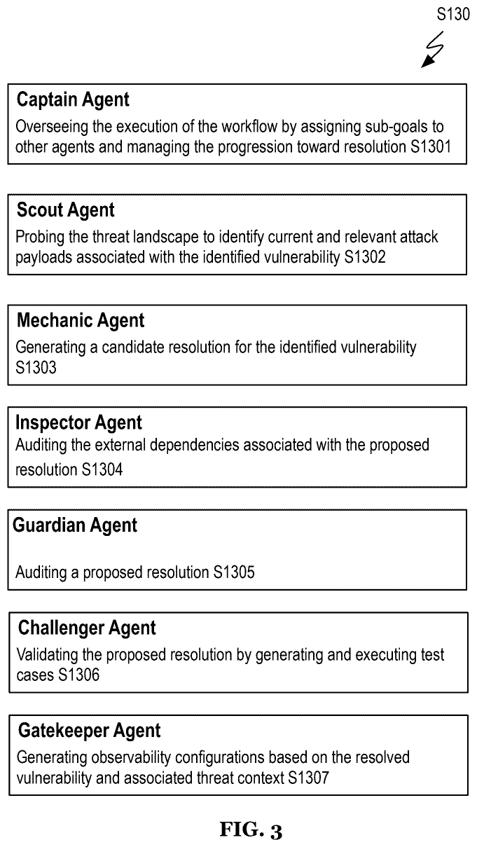

FIG. 4 is an exemplary workflow of a plurality of agents.

FIG. 5 is an exemplary workflow of a plurality of agents with conditional flow between agents.

FIG. 6 is a schematic representation of a system.

FIG. 7 is an exemplary system architecture that may be used in implementing the system and/or method.

### DETAILED DESCRIPTION OF THE EMBODIMENTS

The following description of the embodiments of the invention is not intended to limit the invention to these embodiments but rather to enable a person skilled in the art to make and use this invention.

### 1. Overview

The systems and methods for resolving code vulnerabilities described herein use collaborative artificial intelligent (AI) agents orchestrated within a processing workflow to analyze vulnerabilities, generate resolutions, and validate resolutions. The systems and methods may be used to fully automate vulnerability resolution within software development operations, though the system and methods may additionally support human intervention, input, and/or control.

The systems and methods can use a plurality of specially configured AI agents (more concisely referred herein as agents) that can collaborate on outputting a vulnerability resolution. The systems and methods may use a combination of deep code analysis, context-aware patch generation, and automated testing and validation.

In some variations, the systems and methods may use code context to better generate and validate non-breaking fixes to vulnerabilities, thereby enhancing security and code quality. The systems and methods may use a characterization of a code base to enhance these processes. In particular, the systems and methods may make use of a code property graph (CPG) such as described in U.S. Pat. No. 10,740,470, issued 11 Aug. 2020, titled “SYSTEM AND METHOD FOR APPLICATION SECURITY PROFILING”, which is hereby incorporated in its entirety by this reference. Use of a CPG or alternative code characterization representations may enable accurate, well-vetted fixes with minimal developer effort. A CPG may provide the deep context, which a large language model (LLMs) used by an agent may use to deliver precise, AI-driven remediation.

The systems and methods may integrate seamlessly with existing software development workflows through CI/CD (continuous integration/continuous delivery (and deployment)) pipeline integration. In this way, the systems and methods may work alongside other tools and processes. The systems and methods may be used continuously or on-demand to identify and/or fix vulnerabilities. The systems and methods may free developers to focus on core development tasks.

The systems and methods may be used for any suitable type of software vulnerabilities. For example, the systems and methods may aid in resolving issues including but not limited to SQL injections, cross-site scripting (XSS), authentication issues, or anything else that might be wrong with a code base, even if it's highly specific to a particular codebase.

The systems and methods may deliver trusted and accurate security code resolution or “fix” suggestions that require minimal manual intervention. This streamlines remediation for both development and security teams, allowing developers to focus on building products while reducing overall security risk.

In some variations, the systems and methods may use a multi-agent workflow process, where each agent is dedicated to a specific aspect of the remediation process. This framework is particularly suited for complex tasks, distributing analysis, resolution generation, validation, and refinement across a coordinated group of AI agents. When vulnerabilities are discovered, the agents may analyze the issue, generate a candidate resolution, and test the result using attack payloads and test cases. The agents may also audit dependencies to prevent or mitigate risk of hallucinations and refactor the resolution when audit results fall below confidence thresholds.

By leveraging AI agents and code analysis technologies, the systems and methods help accelerate security workflows without compromising code quality or developer productivity. The agents may operate continuously and in a coordinated manner, ensuring seamless remediation that fits into existing development processes.

The systems and methods may include or work in connection with a user interface (UI). The UI or other tool interfaces may be used for surfacing and flagging vulnerability resolution recommendations. These recommendations can also surface across the Software Development Lifecycle (SDLC), including pull requests, IDEs, and other security tooling.

The system and method may provide a number of potential benefits. The system and method are not limited to always providing such benefits and are presented only as exemplary representations for how the system and method may be put to use. The list of benefits is not intended to be exhaustive, and other benefits may additionally or alternatively exist.

As one potential benefit, the systems and methods may serve to help resolve vulnerabilities in a code base. This may be done automatically or semiautomatically. This can lead to more efficient resolutions of vulnerabilities and/or with less worker overhead.

As another potential benefit, the systems and methods use of multiple agents with specific roles may result in a more predictable and reliable process. Furthermore, orchestration of multiple cooperating agents can use logging so that the handling of vulnerabilities is more easily interpreted. In a similar manner, the systems and methods may include logging of actions to make the process more auditable.

As one potential benefit, the systems and methods may enable seamless and effective remediation without disrupting development workflows. This may allow vulnerabilities to be addressed while developers continue normal operations.

As another potential benefit, the systems and methods may use a plurality of agents, each dedicated to a specific aspect of the problem-solving process. This structure may enable more effective analysis and resolution of complex vulnerabilities. In some variations, the systems and methods may also combine insights from multiple sources, such as threat intelligence feeds, code analysis tools, security forums, and incident reports. For example, given the vulnerability characteristics identified by a code property graph (CPG), the systems and methods may probe the threat landscape to extract current and trending attack payloads.

As another potential benefit, the systems and methods may export outcomes such as identified vulnerabilities, resolutions, or security patterns to enrich other sources. For example, this may include contributing to threat intelligence databases or integrating best practices into developer tools.

### 2. Method

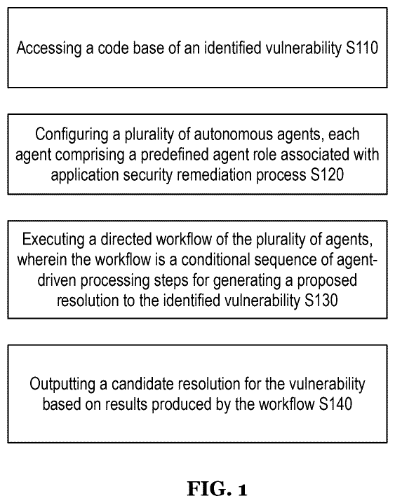

As shown in FIG. 1, a method for resolving code vulnerabilities may include accessing a code base of an identified vulnerability Silo; configuring a plurality of autonomous agents, each agent comprising a predefined agent role associated with application security remediation process S120; executing a directed workflow of the plurality of agents, wherein the workflow is a conditional sequence of agent-driven processing steps for generating a proposed resolution to the identified vulnerability S130; and outputting a candidate resolution for the vulnerability based on results produced by the workflow S140.

The method in some variations will include a plurality of agents with individual agents associated with roles selected from: threat intelligence gathering, resolution or “fix” generation, dependency auditing, data compliance checking, test case generation, and/or observability configuration. These different roles generally can be formed around tasks related to one of analysis, fixing, auditing, or validation of a vulnerability or its resolution. The set of agent roles may additionally include a resolution orchestration role that manages or oversees one or more of the other agents. This list of agent roles is used as one exemplary set of agents. The set of agents may include agents configured for a subset of such roles. Also roles may be merged as a role for one agent or subdivided into sub-roles so that two or more agents may handle different sub-roles. Also, additional or alternative agent roles may also be used.

The workflow may be a coordinated collaboration of these different agents. In some variations, the workflow may more specifically be a directed acyclic graph (DAG) workflow.

As another variation, the method may integrate a scoring heuristic or other evaluation process to either confirm a generated resolution or to reprocess the vulnerability based on scoring thresholds.

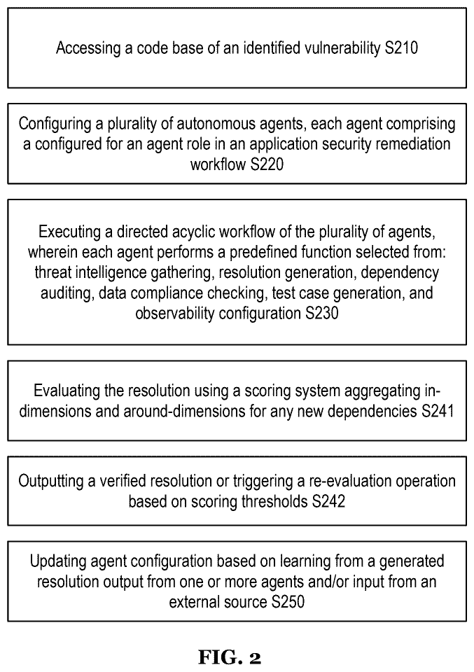

In a method variation with such an exemplary set of agents, use of a DAG-based workflow, and scoring of the result, the method may more specifically be characterized as: accessing a code base of an identified vulnerability S210; configuring a plurality of autonomous agents, each agent comprising a configured for an agent role in an application security remediation workflow S220; executing a directed acyclic workflow of the plurality of agents, wherein each agent performs a predefined function selected from: threat intelligence gathering, resolution generation, dependency auditing, data compliance checking, test case generation, and observability configuration S230; evaluating the resolution using a scoring system aggregating in-dimensions and around-dimensions for any new dependencies S241; outputting a verified resolution or triggering a re-evaluate operation (to regenerate a resolution) based on scoring thresholds S242 as shown in FIG. 2. In some variations, the method may additionally include updating agent configuration based on learning from a generated resolution output from one or more agents, and/or input from an external source S250 as also shown in FIG. 2.

Block S110, which includes accessing a code base of an identified vulnerability, functions to access code or portions of code related to a software vulnerability.

In some variations, the method may include detecting a vulnerability. In some cases, this may be done in connection with user input. In some variations, this may be done through some other software tool. In yet other variations, an agent of an automated application security workflow engine may proactively review code of a code base to identify vulnerabilities.

In some instances, this may be a periodic or continuous process that is performed for a code base. It may be done or triggered in response to changes in a code base and can be integrated into a CI/CD process. In some variations, a vulnerability identification agent may work in connection with a threat intelligence gathering agent (e.g., a scout agent).

In addition to accessing the code base, the method may include analyzing the code base to form a characterization of the code. The characterization may be a generalized characterization of different aspects of a code base. The characterization can be a technical map into characteristics of the code base, and it may be used as a more convenient digested context for agents used in a workflow.

In particular, the method may include analyzing the code base using a code property graph (CPG), which functions to extract semantic structure and control/data flow properties. The CPG may be used as context when configuring or using one or more of the agents. For example, a scout agent, mechanic agent, guardian agent, and/or an inspector agent may use a CPG in performing a task.

The CPG may be graph-based representation of a code base that reflects the interconnected properties of code that combines an abstract syntax tree (AST), a control flow graph (CFG), and a program dependency graph (PDG) into a single, unified structure. By incorporating CPG insights into prompt templates of agents like Scout, Mechanic, Guardian, and Inspector, these agents gain a deeper understanding of the code's structure, semantics, and potential security implications. This enriched context allows agents to more accurately identify vulnerabilities, suggest context-aware fixes/resolutions, and evaluate the security impact of code changes.

An AST functions to characterize the structure and syntax of the code. An AST faithfully encodes how statements and expressions are nested to produce programs. A code parser can create an AST as an ordered tree where inner nodes represent operators and leaf nodes match operands.

The CFG functions to characterize the functional flow of execution within the code as well as conditions that need to be met. The control flow graph can preferably represent sequential and/or possible sequences of execution. The CFG is comprised of statement and predicate nodes, which are connected by directed edges to indicate transfer of control. A statement node has one outgoing edge, and a predicate node has two outgoing nodes corresponding to true and false evaluation of the predicate. The CFG preferably characterizes the calls between functions in the code, the conditional branches within the code, and/or other elements of control flow. For example, a statement preceding an if-statement will have an association into the if-statement or over the if-statement within the CFG. The CFG may be used to determine the execution flow in base code.

The PDG functions to characterize dependencies in the code. The PDG can be a directed graph of a program's control and data dependencies. The nodes of the graph can represent program statements and edges represent dependencies between these statements.

In some variations, the CPG may additionally or alternatively include a directed flow graph, where the DFG functions to show the operations and statements that operate on particular pieces of data. Traversing the edges of the graph can indicate the flow of data. The DFG can additionally capture possible operations.

The AST, CFG, PDG, and/or the DFG may be combined into a joint data structure as the CPG. The three graphs AST, CFG and DFG each have nodes that exist for each statement and predicate of the source code. The statement and predicate nodes can serve as a connection point of the three graphs when joining to form the CPG. Through the three subcomponents, CPG may contain information about the processed code on different levels of abstraction, from dependencies, to type hierarchies, control flow, data flow, and instruction-level information. Passes over the CPG may allow inspection of the base code structure, control flow, and data dependencies of each node, and thus traversing and/or making queries into the CPG may give better understanding of the code base (e.g. by identifying vulnerability patterns).

Block S120, which includes configuring a plurality of autonomous agents, functions to define and initiate a collection of agents for individual roles for collaboration when resolving a vulnerability. Configuring an agent may involve establishing a set of input parameters and behavior settings that guide how the agent performs its designated task. In various implementations, agent configuration may include one or more of: a system prompt defining the agent's role or objective; an instruction prompt specifying detailed behavior or constraints; a context input, which may include vulnerability data, code context, all or a portion of a CPG, or external reference materials; references to training samples or similar resolution examples; selection of one or more large language models (LLMs) to process the prompt; and/or optional performance criteria such as required output format, length, or verification conditions. Configuration may also include parameters for model selection, temperature, max token limits, and use of internal or external tools or APIs for additional analysis or operations.

In some variations, configuring the plurality of agents may comprise configuring prompt configuration of one or more agents using few-shot prompts combined with chain-of-thought reasoning. The prompts may include for example prior resolution examples and explicit reasoning steps. For example, configuring the few-shot prompt configuration may include providing the agent with a limited number of prior problem-solution pairs relevant to a particular vulnerability class or code pattern. These examples may help the agent recognize and apply similar logic to the present task. Chain-of-thought prompting may further be used to guide the agent to break down the task into intermediate reasoning steps, allowing the agent to proceed in a step-by-step fashion from vulnerability detection to resolution generation. Together, few-shot and chain-of-thought prompting can improve both the quality and interpretability of the generated outputs, supporting agents in producing more accurate and logically structured resolutions.

In some variations, configuring the plurality of agents may include setting configuration for: a captain agent, a scout agent, a mechanic agent, an inspector agent, a guardian agent, a challenger agent, and a gatekeeper agent. Each agent may be configured with a role-specific prompt, model selection, context inputs, and validation criteria aligned with its assigned function in the workflow.

Configuring the captain agent may include providing a system prompt that defines its role in orchestrating the overall workflow and managing inter-agent communication. The captain agent may be configured with rules for dispatching sub-goals, tracking progress across nodes in a directed workflow, and ensuring alignment to the final remediation objective. Configuration may also include task allocation strategies and fallback instructions when downstream agents return uncertain or incomplete results. The captain agent as an agent tasked with orchestrating collaboration of multiple agents may also facilitate or manage transition between different agents.

Configuring the scout agent may include defining its function as a threat intelligence collector. The agent may be provided with a prompt template to extract current or relevant attack payloads based on a classified vulnerability or code signature. Inputs may include CPG-derived context, threat intelligence feeds, and prior payload examples. The agent may be configured to use external sources or knowledge bases to identify attack vectors, optionally filtered by date, prevalence, or exploitability.

Configuring the mechanic agent may include providing examples of known fixes, syntax-aware repair instructions, and model parameters for producing safe, context-aware patches. The prompt may instruct the agent to generate a candidate code resolution that addresses the identified vulnerability while preserving application behavior. Configuration may include guidance on how to use a retrieved or provided attack payload and code context to produce a targeted remediation.

The inspector agent may be configured with instructions to audit code dependencies introduced by the mechanic agent's resolution. Configuration may include a scoring framework that evaluates dependencies using weighted in-dimensions and around-dimensions as described herein. The agent may be prompted to flag hallucinated or suspicious packages and return a confidence score or justification. Model selection for this agent may favor reliability and interpretability over creativity.

Configuring the guardian agent may include prompts to audit for privacy, compliance, or sensitive data leakage concerns. Configuration may involve policy definitions aligned with standards such as personally identifiable information (PII), protected health information (PHI), or the General Data Protection Regulation (GDPR). Inputs may include source code, proposed resolution output, and classification labels. The agent may be prompted to report any patterns or expressions matching sensitive data indicators and recommend redactions or modifications if needed.

The challenger agent may be configured to generate and validate test cases designed to confirm that the proposed resolution addresses the underlying vulnerability. Configuration may include prompts that define how to structure test inputs, expected outputs, and edge cases. Few-shot examples of successful tests may be included to guide the agent's generation strategy. The agent may be further configured to compare test outcomes against known exploit scenarios.

Configuring the gatekeeper agent may include instructions for converting vulnerability and resolution metadata into observability or runtime enforcement artifacts. This may include generating machine-readable security policies, telemetry rules, or deployment configurations. The prompt may instruct the agent to produce outputs in formats compatible with external monitoring platforms, such as Open Policy Agent (OPA) or Wiz. Configuration may also include criteria for determining which elements of the resolution warrant observability instrumentation.

Block S130, which includes executing a directed workflow of the plurality of agents, functions to process a vulnerability to determine a proposed resolution. The workflow is a conditional sequence of agent-driven processing steps for generating a proposed resolution to the identified vulnerability.

The workflow may serve as a goal seeking state machine that orchestrates the process from identifying vulnerabilities to suggesting and verifying resolutions, including handling scenarios where the agent detects a hallucinatory package with a low score, which triggers a re-revaluation process.

In some variations, executing the directed workflow is executed according to a graph configuration comprising nodes corresponding to each agent role, and branches based on conditional outcomes produced by each agent. In some such variations, the workflow may be a directed acyclic graph (DAG). The flow may proceed from classification to resolution generation, validation and export stages.

In one example of a DAG based workflow, executing the workflow with a plurality of agents may comprise: classifying a potential vulnerability, conditionally using a scout agent or guardian agent, suggesting a resolution with a mechanic agent, auditing the resolution with an inspector agent, a challenger agent evaluating the resolution, and then outputting a proposed resolution if successful.

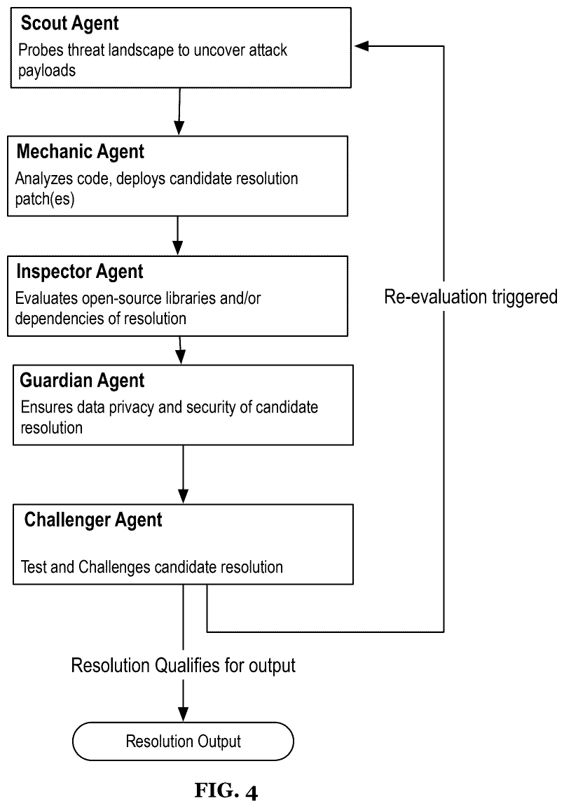

The process may initiate with classifying the finding to determine the nature of the vulnerability. The classification may help in deciding the next steps based on the specific type of vulnerability identified. As shown in FIG. 4, one exemplary workflow may use a scout agent to monitor vulnerability landscape to uncover potential vulnerabilities and then pass off vulnerability resolution to subsequent processing by a mechanic agent, inspector agent, guardian agent and challenger agent. This workflow may be re-evaluated in part or whole depending on a produced resolution or a qualifying resolution may be supplied as output.

Based on the classification, the workflow diverges into two paths: a scout agent flow or a guardian agent flow. The scout agent flow may be initiated for vulnerabilities requiring threat landscape analysis and attack payload identification. The guardian agent flow may be activated for sensitive data exposure, focusing on guidance for handling such leaks.

The mechanic agent may take over processing from the scout and/or guardian agent to suggest a resolution for the vulnerability. This may involve generating code patches or configuration changes based on the vulnerability's context and the information gathered by the scout and/or guardian. The mechanic agent or an additional refactoring agent may also help revise or refine a resolution for enhancing code quality.

Once a resolution is suggested, an inspector agent may audit the external dependencies involved in the resolution/fix of the mechanic agent. This is a critical step to ensure that the suggested resolution does not introduce new vulnerabilities and that all dependencies are safe and reliable.

If the inspector agent detects a hallucinatory package with a low score, indicating a risky or unreliable dependency, this may trigger a re-evaluation process. This involves revisiting the mechanic flow to adjust the resolution based on safer dependencies.

After the Inspector approves the resolution or a re-evaluated resolution is completed, the challenger agent may test the resolution's effectiveness by simulating attacks or generating test cases. The process may end once the challenger agent confirms the resolution's efficacy, ensuring that the vulnerability is adequately addressed. A proposed vulnerability resolution can then be outputted in block S140.

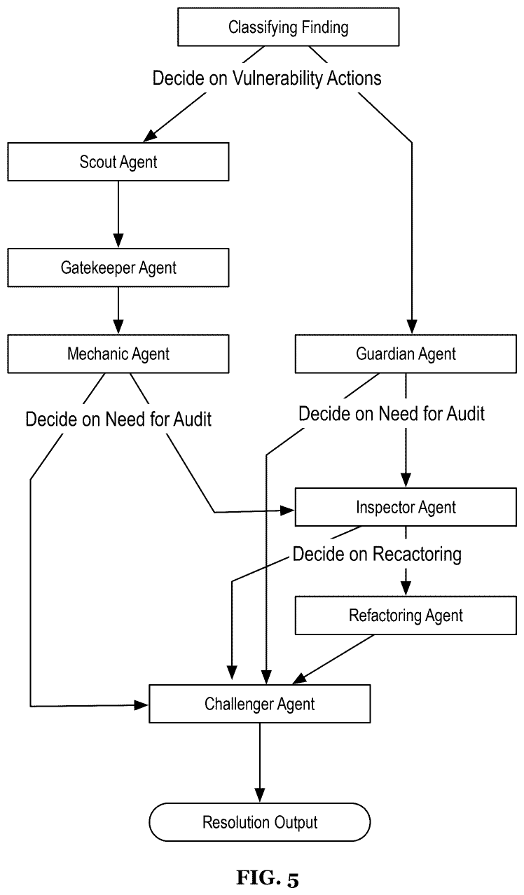

As shown in FIG. 5, the workflow may more dynamically include collaboration from different agents depending on the nature of the vulnerability and/or conditions of a potential resolution. FIGS. 4 and 5 are provided as examples, and the workflow may use a variety of flows for automating generation of a resolution using multiple agents.

As mentioned, in some variations, the plurality of agents may include configuration for: a captain agent, a scout agent, a mechanic agent, an inspector agent, a guardian agent, a challenger agent, and optionally a gatekeeper agent. More generally, the set of agents may include agents configured as a type of analyst agent, an engineer agent to perform code or system updates, and/or a validator agent. Each agent may be configured with a role-specific prompt, model selection, context inputs, and validation criteria aligned with its assigned function in the workflow. As such, executing the directed workflow may include: at the captain agent, orchestrating sub-goals and managing task sequencing within the workflow; at the scout agent, retrieving context-specific attack payloads from external threat intelligence sources based on the classified vulnerability; at the mechanic agent, generating a candidate resolution for the vulnerability using one or more large language models, informed by the retrieved attack payloads and code context; at the inspector agent, computing a vulnerability score for any external dependencies associated with the resolution, the score based on weighted in-dimensions and around-dimensions; at the guardian agent, auditing the candidate resolution for potential leakage of sensitive data in violation of privacy or compliance policies; at the challenger agent, generating and executing test cases to evaluate the effectiveness of the candidate resolution against the identified vulnerability; and/or at the gatekeeper agent, generating one or more observability configurations or security policy artifacts for deployment into production monitoring systems.

In some variations, executing the workflow may include, at a captain agent or other suitably configured agent, overseeing the execution of the workflow by assigning sub-goals to other agents and managing the progression toward resolution S1301. The captain agent may control task sequencing and coordinate agent communication, ensuring that each agent executes in the correct order and that dependencies between agents are satisfied. The captain agent may additionally determine whether sub-goals are completed and may initiate fallback or rerouting logic when downstream agent results are insufficient or missing.

In some variations, executing the workflow may include, at a scout agent or other suitably configured agent, probing the threat landscape to identify current and relevant attack payloads associated with the identified vulnerability S1302. The scout agent may retrieve attack vectors based on vulnerability characteristics, optionally using insights derived from a code property graph (CPG) to inform payload searches. The agent may collect payloads from external sources, including threat intelligence feeds or public vulnerability databases, and may classify payloads based on threat severity or exploit method.

In some variations, executing the workflow may include, at a mechanic agent or other suitably configured agent, generating a candidate resolution for the identified vulnerability S1303. The mechanic agent may receive context from the scout agent and use one or more large language model (LLM) to produce a proposed code patch or configuration change. The agent may incorporate structural insights derived from a CPG to ensure the proposed candidate resolution aligns with application logic and dependencies. In some cases, the mechanic agent may operate in stages, where an initial resolution is generated and then a refined resolution is produced based on downstream validation feedback, such as from the inspector or challenger agents.

In some variations, generation of a candidate resolution may be subdivided into distinct agents with differing roles and objections. For example, a remediation agent may generate an initial code resolution using LLMs and code context, an evaluator may provide notes to improve code, a refinement agent may function like a senior engineer role that reviews notes and serves to refine a resolution. Furthermore a refactoring engineer help rectify dependency issues and/or revise a resolution, potentially after processing by an inspector agent. after inspector feedback.

In some variations, executing the workflow may include, at an inspector agent or other suitably configured agent, auditing the external dependencies associated with the proposed resolution S1304.

The inspector agent may examine third-party libraries, packages, and other referenced components introduced or modified by the mechanic agent to ensure they do not introduce new vulnerabilities. This may also include evaluating the trustworthiness and reliability of used libraries, packages, or other resources. The inspector agent plays a pivotal role in validating that all external dependencies used in the proposed resolution are secure, trustworthy, and properly maintained.

Due to LLM hallucinations, bad actors have started extrapolating hallucinated packages to squat (with backdoors) on commonly generated package hallucinations. The inspector agent serves to protect against such actions.

To support this safeguard, the inspector agent may perform a scoring procedure that computes a vulnerability score for each dependency. The scoring may be based on a combination of multiple evaluation dimensions which may, for example, relate to security, license, maintenance, popularity, and code quality. These dimensions may be divided into two categories: in-dimensions and around-dimensions.

The in-dimensions may contribute a majority weight to the overall score and reflect attributes intrinsic to the dependency itself. These in-dimensions may include the presence of known vulnerabilities, whether the dependency has pinned sub-dependencies to fixed and secure versions, and whether releases are cryptographically signed. The inspector agent may also evaluate whether the dependency includes binary artifacts, whether branch protection measures are enforced in the version control system, and whether the development process involves structured code reviews. Additional in-dimensions may include analysis of contributor reputation (credibility and expertise), the existence and quality of a published security policy, evidence of fuzz testing for security defects, safe packaging practices, and the terms and implications of the dependency's license. As such scoring in-dimension properties may include evaluating in-dimensions comprising at least but not limited to parameters for vulnerability assessment, pinned dependencies, signed releases, binary artifacts, branch protection, code review, contributors, security policy, fuzzing, packaging, and license properties.

The around-dimensions may contribute the remaining weight of the score and relate to broader ecosystem and maintenance factors. These may include an overall library usage score reflecting how widely the dependency is adopted, a maintenance score based on update frequency and responsiveness to reported issues, and a bus factor score indicating the number of contributors with sufficient project knowledge to sustain development. The popularity of the dependency in the developer community and a general security score based on external audits and community assessments may also be considered.

The inspector agent may compute a cumulative vulnerability score by aggregating the in-dimension and around-dimension scores using a weighted average, such as sixty percent from in-dimensions and forty percent from around-dimensions.

Based on this score, the dependency may be categorized into safety tiers. A dependency with a score of 8.0 or higher may be considered safe to use. A score between 6.0 and 7.9 may indicate caution is needed and further evaluation may be required. A score below 6.0 may be considered unsafe, and the dependency may be rejected or require substitution.

In addition to scoring, the inspector agent may evaluate whether any of the dependencies are hallucinated. Hallucinated packages refer to dependencies fabricated by a generative model, which may not exist in verified artifact repositories. The presence of such hallucinated dependencies can be dangerous, as malicious actors may upload similarly named packages containing backdoors or other harmful code. The inspector agent may compare dependency names against known package registries and flag unknown or low-confidence dependencies. In such cases, the inspector agent may output a rejection or warning and may trigger a re-evaluation process to prompt the mechanic agent to regenerate a resolution using alternate dependencies.

In some embodiments, the inspector agent may also use insights from a code property graph to analyze how dependencies are used within the application. This may include tracing the flow of data through imported functions, identifying high-risk code paths influenced by external packages, or assessing transitive dependencies. Based on this deeper context, the inspector agent may make more accurate determinations about dependency trustworthiness and integration safety.

The output of the inspector agent may serve as a gating step in the workflow. If the dependency analysis fails to meet minimum safety thresholds, the system may automatically re-enter an earlier stage of the workflow to revise the resolution. This loop may continue until a satisfactory resolution with secure, reliable dependencies is produced.

In some variations, executing the workflow may include, at a guardian agent or other suitably configured agent, auditing a proposed resolution S1305. The audit may check the resolution for sensitive data leakage and compliance with privacy and security standards. The guardian agent may evaluate whether any part of the resolution introduces or exposes personally identifiable information (PII), protected health information (PHI), or violates policies under the General Data Protection Regulation (GDPR). The guardian agent may apply pattern-matching or rule-based logic informed by CPG insights to locate potential data leak points and may generate compliance warnings or suggest redactions. In some implementations, the guardian agent may include evaluator logic for generating feedback on quality or completeness and may interface with downstream refinement agents or redirect processing to an earlier agent for updating a resolution.

In some variations, executing the workflow may include, at a challenger agent or other suitably configured agent, validating the proposed resolution by generating and executing test cases S1306. The challenger agent may construct unit tests based on the original vulnerability, the resolution, and the associated attack payloads. These test cases may be designed to simulate attack scenarios or confirm that previously vulnerable code paths are no longer exploitable. The challenger agent may execute the test suite and return pass/fail results to the workflow, which may be used to approve or revise the resolution.

In some variations, executing the workflow may include, at a gatekeeper agent or other suitably configured agent, generating observability configurations based on the resolved vulnerability and associated threat context S1307. The gatekeeper agent may produce machine-readable outputs such as alerting rules, policy files, or telemetry configurations compatible with monitoring platforms like Splunk or Wiz. These outputs may be derived from the attack payloads, affected code regions, or resolution metadata identified earlier in the workflow. The configurations may be used to detect future exploitation attempts, enforce runtime guardrails, or improve visibility into system behavior following remediation.

In some variations, the systems and methods may employ multiple large language models (LLMs) to enhance the quality and reliability of outputs generated during the agent workflow. Multiple LLMs may be used by one or more agents and can be used in self-verifying outcomes.

The method, and more specifically operations performed at one or more agent, may include verifying outputs across a plurality of large language models (LLMs), the verification may include comparison of suggested resolutions to detect hallucinations or inconsistencies or errors in the generated outputs. This may be used for corrections and refinements. This may make resolutions complete, accurate, and robust. This step may be beneficial for maintaining the quality and reliability of the solutions provided by the autonomous AppSec agents, ensuring that the candidate resolution(s) are not only effective but also safe and secure.

As mentioned, the integration of CPG insights into agent prompt templates, combined with advanced prompting techniques like few-shot prompts and the chain of thought approach, significantly enhances the agents' ability to tackle complex security vulnerabilities. The self-verification of outcomes across LLMs further ensures the quality and reliability of the solutions generated by these agents. Together, these strategies enable the autonomous AppSec framework to provide comprehensive, context-aware, and robust security solutions, thereby augmenting the capabilities of security teams and improving the overall security posture of software applications.

Block S140, which includes outputting a candidate resolution for the vulnerability based on results produced by the workflow, functions to produce an output with a proposed resolution or task to address or mitigate a vulnerability. The resolution may be committed as a pull request for a code repository, which may then be reviewed and integrated within a CI/CD process.

In some variations, the type of resolution may trigger different actions. For example, in some variations, the resolution may be determined to be low risk and/or the vulnerability a significant enough risk that a resolution may be automatically added to a code repository. In other scenarios, the resolution may be made as a pull request which may undergo similar review as other code commits from other developers. Additionally, one or more of the agents may add supplemental notes to a vulnerability resolution which may trigger different actions. For example, an agent of the workflow may flag different review processes and steps that should be performed as part of integrating the resolution. For example, different teams or contributors may be messaged. These messages may be informational and/or may require human action such as approving a resolution.

In one variation, the method may include providing a dashboard interface to review agent outputs and allow selective approval or revision before pushing the resolution to downstream systems. The dashboard can serve as a human accessible interface. Additionally or alternatively, the method may provide a programmatic interface (e.g., an API), through which other computer or AI systems may use results of the workflow.

In some variations, the dashboard interface may be used for modifying an agent output through an external input like user input. The modified output may be a modification of the generated code for resolving a vulnerability, comments or feedback on the resolution, additional data, or any suitable supplemental input. This may be used by developers to check different conditions. For example, a security engineer may supply additional test conditions, a programmer may make modifications to the suggested code edits, a manager may be able to add comments or questions for consideration in re-evaluating the proposed resolution. The external input can be made to the final resolution output but may additionally or alternatively be made on any agent input or output. Additionally multiple users may be able to augment data used within a workflow. A user may supplement with notes or direction, provide additional context (e.g., adding external security reports, resolution samples from other code sources, etc.), code edits, conversational questions or prompts, or other suitable inputs.

Modification of an agent output may then trigger, re-executing the directed workflow. In some variations, this re-execution may happen starting at a node in the workflow graph corresponding to a modification (e.g., a modified output or input).

The resolution outputs produced by autonomous application security workflows, such as identified vulnerabilities, suggested resolutions, and even new security patterns, can be exported to enrich other sources. For instance, successfully implemented resolutions can be shared with code repositories or integrated into developer tools as part of best practice guides. Insights gained from the process can contribute to threat intelligence databases, enhancing the collective knowledge base of the security community. Furthermore, by feeding these outcomes back into the system, the autonomous agents can learn and improve over time, creating a virtuous cycle of continuous improvement and knowledge sharing. For example, given the attack payloads and remediation location in application, auto-generate a OPA based Wiz policy for the running application to enhance observability

The method may additionally include processes for improving performance of the agents and workflow. The method may include logging successful agent outputs, workflows, and context; and using the logged data to update the configuration or prompt templates of one or more agents to support continuous learning. Captured user input may be used as one signal to evaluate the quality or value of generated outputs. Approval of pull requests may also be another signal to evaluate the quality or value of generated outputs.

Furthermore, this method may be executed as a standalone solution for one code base. The method may automatically learn and adapt to the particular properties of that code base. The method may alternatively be provided as a security service (e.g., through a software as a service computing platform), wherein the workflow and/or the agents may benefit from providing security review of multiple code bases. Vulnerabilities may be commonly exploited across different code bases, and so the method may enable generated resolutions to more securely and reliably be made on other code bases.

### 3. System

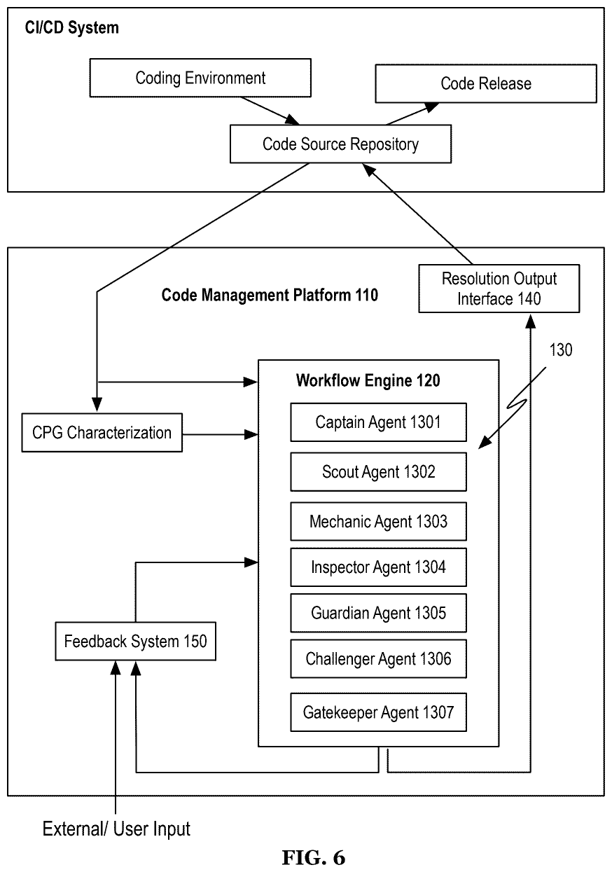

As shown in FIG. 6, a system for resolving code vulnerabilities may include a code management platform 110 configured to provide access to a code source for analysis; the code management platform can include a code input interface 112 for receiving code or vulnerability data; an automated application security workflow engine 120 comprising a directed graph workflow of a plurality of agent modules 130 (i.e., agents), wherein each agent of the plurality of agents comprises configuration for a distinct role in security resolution; and a resolution output interface 140. The system may additionally include a feedback system 150. The system is preferably configured and used for executing the method as described above, and variations described for the method and/or herein may similarly be applied and implemented by a system variation.

In some alternative system implementations, a system may be or include one or more non-transitory computer-readable medium storing instructions that, when executed by one or more computer processors, cause a computer to perform a method comprising steps of the method such as accessing a code base of an identified vulnerability; configuring a plurality of autonomous agents, each agent comprising a predefined agent role associated with application security remediation process; executing a directed workflow of the plurality of agents, wherein the workflow is a conditional sequence of agent-driven processing steps for generating a proposed resolution to the identified vulnerability; and outputting a candidate resolution for the vulnerability based on results produced by the workflow.

The code management platform 110 functions as a computing resource for interfacing with or managing a code base. The code management platform in one variation may be part of a computing system implemented in connection with a specific code base. For example, a software application may setup the code management platform 110 as an automated application security tool that can be used as part of the development process of the application. In another example, the code management platform no may be a cloud-based security platform that can provide automated application security services to multiple different applications. The code management platform may be granted permissions to access and interface with a code base.

The code management platform 110 or the system more generally can include a code input interface 112, which functions as some mechanism through which access to a code base or part of a code base may be acquired. In some variations, the full code base may be accessible. In other variations, portion of code such as a particular library or code relevant to a particular vulnerability may be supplied.

The code management platform no or the system may include code characterization module which may generate a CPG or other type of code characterization. In some variations, a CPG may be externally generated and supplied as input to the system.

The automated application security workflow engine 120 functions as a computer-based processing system that manages the collaboration of multiple agents within some coordinated processing workflow.

The workflow engine may be configured with a directed acyclic graph workflow, which comprises nodes corresponding to different agent modules and edges representing conditional transitions based on agent outcomes and outputs. Transitions between nodes of the workflow in this variation may correspond to handoff of tasks between different agents.

As discussed, the plurality of agents may include a variety of different types of agents. In general the agent modules 130 may be configured for different classifications of roles including but not limited to analyst agents, engineer agents, and validator agents.

In particular, the plurality of agents may include a captain agent 1301 configured to coordinate workflow execution and task delegation; a scout agent 1302 configured to retrieve context-specific attack payloads from threat intelligence sources; a mechanic agent 1303 configured to generate a candidate code resolution; an inspector agent 1304 configured to audit dependencies of the resolution; a guardian agent 1305 configured to verify compliance with sensitive data protection policies; a challenger agent 1306 configured to generate and evaluate unit tests; and a gatekeeper agent 1307 configured to generate observability or monitoring configurations based on the resolution. This may be integrated into a coordinated flow such as shown in FIG. 4 or FIG. 5.

The agent modules 130 function as specially configured AI agents. The agents may include interfaces to one or more LLMs and/or tools. The agent modules may additionally include distinct configuration or prompting which may provide sample inputs and outputs, system prompts, context data, access or interfaces to data, and/or other suitable configuration. There may be commonly shared configuration, but each agent may include agent-specific configuration that is specially configured for role of an agent within the workflow.

The captain agent functions to coordinate workflow execution and optionally delegate tasks across the plurality of agent modules. Also referred to in some variations as an orchestration agent or workflow orchestration agent, the captain agent may be responsible for managing or overseeing the flow of execution between agents and ensuring that each agent receives appropriate inputs and initiates its task at the correct stage. The captain agent may include internal observability components to monitor progress and results within the workflow. It may further include logic to manage conditional branching, track the completion of sub-goals, and determine when fallback or re-execution is required. The module may include configuration interfaces for defining agent dependencies, state transitions, and execution order within a directed graph or other structured workflow representation.

The scout agent functions to gather intelligence on vulnerabilities such as by retrieving context-specific attack payloads from threat intelligence sources. Sometimes referred to as a threat intelligence agent, the scout agent may be configured to access external feeds, repositories, or databases of exploit data. The module may include an interface to large language models for interpreting vulnerability descriptions and mapping them to known threat vectors. Configuration may include prompts, templates, or classifiers used to guide data retrieval based on the specific context of a vulnerability. In some implementations, the scout agent may include access to the code property graph (CPG) data to correlate vulnerable code segments with likely attack types, enhancing the relevance of retrieved payloads.

The mechanic agent functions to generate a candidate code resolution for the identified vulnerability. Also referred to as a resolution generation agent or engineering agent, the mechanic module may be configured with access to one or more large language models for code synthesis. In some variations, the module may interface with a code property graph (CPG) engine to obtain structural or semantic context from the affected codebase. The mechanic agent may support different internal configurations, such as separate submodules for initial resolution generation, resolution evaluation, and/or post-inspection refinement (e.g., code refactoring). Configuration parameters may include prompt templates, model selection, temperature settings, and formatting rules for the generated patch output. The module may also include logic for contextualizing its output based on threat information received from the scout agent.

The inspector agent functions to audit the dependencies introduced or modified by a proposed resolution. Sometimes referred to as a dependency auditing agent, this module may be configured with access to both public package registries and private code repositories to evaluate the safety, trustworthiness, and relevance of external packages. The inspector agent may include integration with a CPG engine to identify how dependencies are used within the codebase. The module may include a scoring component or engine for computing a composite vulnerability score for each dependency, based on predefined in-dimensions and around-dimensions. The vulnerability score may be a weighted vulnerability score. The module may flag hallucinated or unverified packages and output a confidence score or usage recommendation. Configuration may include rulesets, scoring weights, trust thresholds, and external verification hooks.

The guardian agent functions to verify that the proposed resolution complies with relevant data protection policies and does not expose sensitive information. Also referred to as a data compliance or data auditing agent, the guardian agent may examine code changes and context using a combination of pattern-matching, classification, and code analysis tools. In some variations, the agent may interface with a CPG to locate data flow paths involving personally identifiable information (PII), protected health information (PHI), or other regulated data types. Configuration for this module may include privacy policy definitions, compliance rule templates, and redaction or notification procedures. The agent may be used as a gating step to detect and report privacy violations before the code resolution proceeds to testing or deployment.

The challenger agent functions to generate and evaluate unit tests for the proposed resolution. Also referred to as a test generator agent, this module may be configured to produce test cases designed to validate that the vulnerability has been effectively resolved. The challenger agent may include interfaces to internal test suites as well as external test case generation tools or repositories. For example, the challenger agent may include a test harness configured to execute generated unit tests and record outcome traces. Configuration may include logic for deriving test inputs based on attack payloads, expected outputs, and pre-fixed behavior. The module may include mechanisms for executing tests and evaluating pass/fail criteria, with the ability to output structured test results to other agents or external review systems.

The gatekeeper agent functions to generate observability and monitoring configurations based on the resolution and related vulnerability context. Also referred to as a monitoring agent, this module may produce configuration files or policy artifacts for external platforms such as Splunk or Wiz. These outputs may be used to enable runtime detection of future attacks, monitor usage of vulnerable code paths, or enforce system-level protections. In this way the gatekeeper agent may include a policy generation module for producing machine-readable observability rules. The gatekeeper agent may work as an additional or optional agent that uses a generated resolution for supplemental security monitoring features. The gatekeeper agent may include interfaces to telemetry systems, security policy engines, or configuration management tools. It may be triggered after the resolution has passed inspection and validation, using resolution metadata and attack patterns to create meaningful and actionable observability rules.

The resolution output interface 140 functions as a component used to deliver or integrate a proposed resolution for fixing a vulnerability. The resolution output interface 140 may be implemented as an interface to a code repository where a generated and approved resolution may be added as a pull request for a code repository. In other variations, the resolution output interface may be surfaced within a dashboard or other type of user interface. A user or another system may review or use the surfaced resolution to take appropriate action. As discussed in some variations, a user interface may be exposed through which users or other external systems may supplement, edit or otherwise provide input to the workflow. Input or output of any agent may be modified or have feedback added. This may trigger re-evaluation of resolution. When input made to one particular agent then that work of that agent may be re-evaluated and the workflow continued from there. In other variations, the vulnerability may be completely re-evaluated using the supplied information.

The input may be supplied by any suitable type of feedback system 150. The feedback system may additionally be used to update and refine agents for subsequent work. Successful and unsuccessful resolution attempts may all be used to improving performance of the system.

### 4. Examples

Hereafter are described different examples of system and/or method variations. These examples are not intended to limit the systems and/or methods and their variations, and these examples do not include every variation and combination of variations of the systems and methods described herein.

Example 1.1: A method comprising: accessing a code base of an identified vulnerability; configuring a plurality of autonomous agents, each comprising a predefined agent role associated with application security remediation process; executing a directed workflow of the plurality of agents, wherein the workflow is a conditional sequence of agent-driven processing steps for generating a proposed resolution to the identified vulnerability; and outputting a candidate resolution for the vulnerability based on results produced by the workflow.

Example 1.2 The method of example 1.1 or other examples, wherein each agent of the plurality of agents is configured with a distinct role profile.

Example 1.3 The method of example 1.2 or other examples, wherein the plurality of agents includes configuration for: a captain agent, a scout agent, a mechanic agent, an inspector agent, a guardian agent, a challenger agent, and a gatekeeper agent; and wherein executing the directed workflow comprises: at the captain agent, orchestrating sub-goals and managing task sequencing within the workflow; at the scout agent, retrieving context-specific attack payloads from external threat intelligence sources based on the classified vulnerability; at the mechanic agent, generating a candidate resolution for the vulnerability using one or more large language models, informed by the retrieved attack payloads and code context; at the inspector agent, computing a vulnerability score of dependencies used in the candidate resolution; at the guardian agent, auditing the candidate resolution for potential leakage of sensitive data in violation of privacy or compliance policies; at the challenger agent, generating and executing test cases to evaluate the effectiveness of the candidate resolution against the identified vulnerability; and at the gatekeeper agent, generating one or more observability configurations or security policy artifacts for deployment into production monitoring systems.

Example 1.4: The method of example 1.3 or other examples, wherein executing the directed workflow is executed according to a graph configuration comprising nodes corresponding to each agent role, and branches based on conditional outcomes produced by each agent.

Example 1.5: The method of example 1.3 or other examples, wherein computing a vulnerability score of dependencies used in the candidate resolution comprises at the inspector agent computing a vulnerability score based on a weighted aggregation of: in-dimensions comprising vulnerability history, binary artifacts, code review quality, contributor trustworthiness, and fuzzing usage; and around-dimensions comprising library popularity, maintenance score, and security audit score.

Example 1.6: The method of example 1.2 or other examples, further comprising: analyzing the code base using a Code Property Graph (CPG) to extract semantic structure and control/data flow properties used as context for at least one of the plurality of agents.

Example 1.7: The method of example 1.1 or other examples, wherein configuring the plurality of agents comprises configuring prompt configuration of one or more agents using few-shot prompts combined with chain-of-thought reasoning, the prompts comprising prior resolution examples and explicit reasoning steps.

Example 1.8: The method of example 1.1 or other examples, further comprising: verifying outputs across a plurality of large language models (LLMs), the verification comprising comparison of suggested resolutions.

Example 1.9: The method of example 1.1 or other examples, further comprising: providing a dashboard interface to review agent outputs and allow selective approval or revision before pushing the resolution to downstream systems.

Example 1.10: The method of example 1.1 or other examples, further comprising: further comprising: modifying an agent output through external input; and re-executing the directed workflow from the node in the workflow graph corresponding to the modified output.

Example 1.11: The method of example 1.1 or other examples, further comprising: further comprising: logging successful agent outputs, workflows, and context; and using the logged data to update the configuration or prompt template of one or more agents to support continuous learning.

Example 1.12: A system comprising: a code review and management platform configured to provide access to source code for analysis with a code input interface code of a vulnerability; an automated application security workflow engine comprising a directed graph workflow structure; a plurality of autonomous agent modules communicatively coupled within the workflow engine, each agent module comprising configuration data defining a distinct role in vulnerability resolution; and a resolution output interface for outputting a resolution based on the workflow.

Example 1.13: The system of example 1.14 or other examples, wherein the plurality of agents comprises: a captain agent configured to coordinate workflow execution and task delegation; a scout agent configured to retrieve context-specific attack payloads from threat intelligence sources; a mechanic agent configured to generate a candidate code resolution; an inspector agent configured to audit dependencies of the resolution; a guardian agent configured to verify compliance with sensitive data protection policies; a challenger agent configured to generate and evaluate unit tests; and a gatekeeper agent configured to generate observability or monitoring configurations based on the resolution.

Example 1.14: The system of example 1.13 or other examples, wherein the workflow engine is configured as a directed acyclic graph (DAG) comprising nodes corresponding to agent modules and edges representing conditional transitions based on agent outcomes.

Example 1.15: The system of example 1.13 or other examples, further comprising a feedback system configured to log workflow outputs and update one or more agent modules based on resolution generation performance.

### 5. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., non-transitory computer-readable mediums) storing instructions that, when executed by the one or more computer processors, cause a computing platform to perform operations comprising those of the system or method described herein such as: accessing a code base of an identified vulnerability; configuring a plurality of autonomous agents, each agent comprising a predefined agent role associated with application security remediation process; executing a directed workflow of the plurality of agents, wherein the workflow is a conditional sequence of agent-driven processing steps for generating a proposed resolution to the identified vulnerability; and outputting a candidate resolution for the vulnerability based on results produced by the workflow.

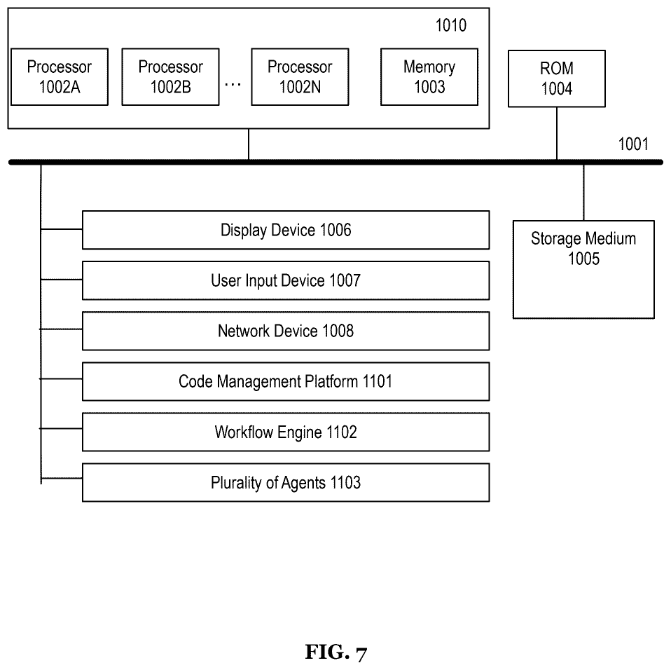

FIG. 7 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random-access memory (RAM)) 1003, a read only memory (ROM) 1004, a processor-readable storage medium 1005, a display device 1006, a user input device 1007, and a network device 1008. As shown, the computer infrastructure may be used in connecting code management platform 1101, workflow engine 1102, plurality of agents 1103, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid-state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
accessing a code base of an identified vulnerability;
configuring a plurality of autonomous agents, each comprising a predefined agent role associated with application security remediation process;
executing a directed workflow of the plurality of agents, wherein the workflow is a conditional sequence of agent-driven processing steps for generating a proposed resolution to the identified vulnerability; and
outputting a candidate resolution for the vulnerability based on results produced by the workflow.

2. The method of claim 1, wherein each agent of the plurality of agents is configured with a distinct role profile.

3. The method of claim 2, wherein the plurality of agents includes configuration for: a captain agent, a scout agent, a mechanic agent, an inspector agent, a guardian agent, a challenger agent, and a gatekeeper agent; and wherein executing the directed workflow comprises:
at the captain agent, orchestrating sub-goals and managing task sequencing within the workflow;
at the scout agent, retrieving context-specific attack payloads from external threat intelligence sources based on the classified vulnerability;
at the mechanic agent, generating a candidate resolution for the vulnerability using one or more large language models, informed by the retrieved attack payloads and code context;
at the inspector agent, computing a vulnerability score of dependencies used in the candidate resolution;
at the guardian agent, auditing the candidate resolution for potential leakage of sensitive data in violation of privacy or compliance policies;
at the challenger agent, generating and executing test cases to evaluate the effectiveness of the candidate resolution against the identified vulnerability; and
at the gatekeeper agent, generating one or more observability configurations or security policy artifacts for deployment into production monitoring systems.

4. The method of claim 3, wherein executing the directed workflow is executed according to a graph configuration comprising nodes corresponding to each agent role, and branches based on conditional outcomes produced by each agent.

5. The method of claim 3, wherein computing a vulnerability score of dependencies used in the candidate resolution comprises at the inspector agent computing a vulnerability score based on a weighted aggregation of: in-dimensions comprising vulnerability history, binary artifacts, code review quality, contributor trustworthiness, and fuzzing usage; and around-dimensions comprising library popularity, maintenance score, and security audit score.

6. The method of claim 2, further comprising: analyzing the code base using a Code Property Graph (CPG) to extract semantic structure and control/data flow properties used as context for at least one of the plurality of agents.

7. The method of claim 1, wherein configuring the plurality of agents comprises configuring prompt configuration of one or more agents using few-shot prompts combined with chain-of-thought reasoning, the prompts comprising prior resolution examples and explicit reasoning steps.

8. The method of claim 1, further comprising: verifying outputs across a plurality of large language models (LLMs), the verification comprising comparison of multiple proposed resolutions.

9. The method of claim 1, further comprising: providing a dashboard interface to review agent outputs and allow selective approval or revision before pushing the resolution to downstream systems.

10. The method of claim 1, further comprising: further comprising: modifying an agent output through external input; and re-executing the directed workflow from the node in the workflow graph corresponding to the modified output.

11. The method of claim 1, further comprising: further comprising: logging successful agent outputs, workflows, and context; and using the logged data to update the configuration or prompt template of one or more agents to support continuous learning.

12. A system comprising:
a code review and management platform configured to provide access to source code for analysis with a code input interface code of a vulnerability;
an automated application security workflow engine comprising a directed graph workflow structure;
a plurality of autonomous agent modules communicatively coupled within the workflow engine, each agent module comprising configuration data defining a distinct role in vulnerability resolution; and
a resolution output interface for outputting a resolution based on the workflow.

13. The system of claim 12, wherein the plurality of agents comprises:
a captain agent configured to coordinate workflow execution and task delegation;
a scout agent configured to retrieve context-specific attack payloads from threat intelligence sources;
a mechanic agent configured to generate a candidate code resolution;
an inspector agent configured to audit dependencies of the resolution;
a guardian agent configured to verify compliance with sensitive data protection policies;
a challenger agent configured to generate and evaluate unit tests; and
a gatekeeper agent configured to generate observability or monitoring configurations based on the resolution.

14. The system of claim 13, wherein the workflow engine is configured as a directed acyclic graph (DAG) comprising nodes corresponding to agent modules and edges representing conditional transitions based on agent outcomes.

15. The system of claim 13, further comprising a feedback system configured to log workflow outputs and update one or more agent modules based on resolution generation performance.
